(19) United States
(12) Patent Application Publication
(10) Pub. No.: US 2024/0111317 A1
(43) Pub. Date: Apr. 4, 2024

(54) OPTIMIZATION OF ENERGY USE THROUGH MODEL-BASED SIMULATIONS

(71) Applicant: Tendril OE, LLC, Boulder, CO (US)

(72) Inventor: Charles D. Corbin, Boulder, CO (US)

(21) Appl. No.: 18/481,190

(22) Filed: Oct. 4, 2023

Related U.S. Application Data
(63) Continuation of application No. 17/707,929, filed on Mar. 29, 2022, now Pat. No. 11,782,465.
Application No. 17/707,929 is a continuation of application No. 16/894,508, filed on Jun. 5, 2020, now Pat. No. 11,385,664.
Application No. 16/894,508 is a continuation of application No. 13/564,623, filed on Aug. 1, 2012, now Pat. No. 10,678,279.

(51) Int. Cl. G05D 23/19

(52) U.S. Cl. CPC G05D 23/1923; F24F 2130/00

(57) ABSTRACT

A facility implementing systems and/or methods for achieving energy consumption/production and cost goals is described. The facility identifies various components of an energy system and assesses the environment in which those components operate. Based on the identified components and assessments, the facility generates a model to simulate different series/schedules of adjustments to the system and how those adjustments will effect energy consumption or production. Using the model, and based on identified patterns, preferences, and forecasted weather conditions, the facility can identify an optimal series or schedule of adjustments to achieve the user's goals and provide the schedule to the system for implementation. The model may be constructed using a time-series of energy consumption and thermostat states to estimate parameters and algorithms of the system. Using the model, the facility can simulate the behavior of the system and, by changing simulated inputs and measuring simulated output, optimize use of the system.

### TECHNICAL FIELD

This application is a continuation of U.S. patent application Ser. No. 17/707,929, titled OPTIMIZATION OF ENERGY USE THROUGH MODEL-BASED SIMULATION, filed Mar. 29, 2022, which is a continuation of U.S. patent application Ser. No. 16/894,508, titled METHODS AND APPARATUS FOR ACHIEVING ENERGY CONSUMPTION GOALS THROUGH MODEL-BASED SIMULATIONS, filed Jun. 5, 2020, which is a continuation of U.S. patent application Ser. No. 13/564,623, titled OPTIMIZATION OF ENERGY USE THROUGH MODEL-BASED SIMULATIONS, filed Aug. 1, 2012, all of which are incorporated herein in their entirety by reference thereto.

### TECHNICAL FIELD

The present disclosure is directed to optimization of energy usage based on users goals and preferences, and more particularly to optimization of energy usage using model-based simulations.

### BACKGROUND

As non-renewable energy resources are being depleted and energy costs become increasingly more expensive and volatile, consumers continue to seek out ways to reduce their energy consumption and energy costs. Many energy systems (e.g., energy-consuming or energy-producing systems) allow users to establish automated schedules that dictate how and when the energy systems should be used. For example, a heating and cooling system may allow a user to set temperatures for different times of day, such as a “wake” time and temperature, an “away” time and temperature, a “return” time and temperature, and a “sleep” time and temperature. At the predetermined times the system adjusts to the predetermined temperatures. However, these systems require a user to both configure them properly and, more importantly, adjust the times and temperatures to adapt to changing needs and concerns with respect to energy consumption or production. These systems do not take into account the amount of energy used, or the cost of the energy used. An intelligent system for adapting to changing energy costs and energy needs while achieving user goals with respect to energy consumption or production and costs is desired.

### BRIEF DESCRIPTION OF THE DRAWINGS

FIG. 1 is a block diagram illustrating an environment in which the facility may operate.

FIG. 2 is a block diagram illustrating components of the facility.

FIG. 3 is a block diagram illustrating the processing of an optimize module of the facility.

FIG. 4 is a block diagram illustrating the processing of a learn module of the facility.

FIG. 5 is a block diagram illustrating the processing of a detect patterns module of the facility.

### DETAILED DESCRIPTION

A facility implementing systems and/or methods for achieving energy consumption or production and cost goals is described. The facility identifies various components of an energy system, such as a heating, ventilation, and air condition (HVAC) system, load-control switch, hot water heater, electric vehicle, electric appliance, solar system, etc. and assesses the environment in which those components operate, such as the thermal capacitance of a building in which a HVAC system operates, current and forecasted weather conditions, and energy costs. Based on the identified components and assessments, the facility generates a simulation model that can be used to simulate different time-based series or schedules of adjustments to the energy system and how those adjustments will effect energy consumption. For example, the facility may use the simulation model to calculate the amount of energy consumed or the cost of the energy consumed for different heating/cooling schedules for an HVAC system. Based on user patterns and preferences (e.g., when users consume energy, whether a user desires to reduce energy costs and/or energy consumption, when users prefer certain appliances to operate), the facility can identify an optimal series or schedule of adjustments for the user and provide the schedule to the system for implementation. As another example, the facility may use the simulation model to calculate the amount of energy produced or the value of the energy produced. Additionally, the facility can configure the system to operate in accordance with a demand profile received from a utility.

For example, the simulations may show that “heating/cooling schedule A” causes the HVAC system to consume 50 kilowatt hours (kWh) of energy per day at an average cost of 50 per kWh ($2.50 per day) while heating/cooling schedule B causes the HVAC system to consume 60 kWh per day at an average cost of 40 per kWh ($2.40 per day). Accordingly, a user looking to reduce energy costs may choose schedule B while a user looking to reduce energy consumption may choose schedule A. In this manner, the facility can optimize the HVAC system to achieve user goals with respect to energy use. As another example, a utility may provide a demand schedule and encourage users to implement the schedule to receive discounts or other compensation. The facility can, using the demand schedule, configure the system to comply with the energy consumption preferences of the utility.

In some embodiments, the facility operates in a learning mode to identify components of an energy system. When working in conjunction with an HVAC system, for example, the facility may query a thermostat and/or other components to identify the different components in the system, such as air-conditioning units, sensors, photovoltaic systems (e.g., roof-mounted photovoltaic systems), fans, pumps, etc. In other examples, the facility may provide a user interface through which a user can manually identify the various components in the system. As another example, when working in conjunction with an electric vehicle, the facility may identify the electric vehicle and its battery.

In addition to identifying components while in the learning mode, the facility may also perform tests to identify attributes of the energy system and the environment in which the system operates. For example, the facility may perform a number of tests on an HVAC system, such as a heating step test, a free-float test, and a cooling step test while monitoring different areas (e.g., rooms) of the surrounding environment to determine where and how fast the various areas acquire or lose heat. Based on the information collected during the monitoring phase, the facility can employ system identification techniques, such as those described in Applied System Identification by Jer-Nan Juang (Prentice Hall, 1994), which is herein incorporated by reference, to determine attributes of the energy system and environment, such as an envelope resistance, thermal capacitance, thermal resistance, and heating capacity of a building in which the HVAC system operates. One skilled in the art will understand that the facility may determine additional attributes of the environment, such as occupancy schedule, internal gains, the schedule of internal gains, window area, window properties, wall/roof/floor area, wall/roof/floor insulation, wall/roof/floor thermal capacitance, wall/roof/floor thermal state (temperature) heating and cooling set points and their schedule, heating equipment efficiency, fan energy consumption, cooling equipment efficiency, infiltration, exterior shading, photovoltaic system efficiency, photovoltaic system orientation, electric vehicle capacity, electric vehicle charging rate, electric vehicle state of charge, appliance energy consumption, appliance schedule, and so on. The facility may also determine ranges of operating conditions for various components of the energy system, such as the available settings for each fan, blower, vent, heating unit, cooling unit, etc. and the amount of energy that the system and each component of the system consumes while in use, such as how much energy an HVAC system and/or an air conditioner consume while cooling a building from one temperature set point to another temperature set point or how much energy the HVAC system, central heating unit, fans, blowers, etc. consume while heating from one set point to another. As another example, the facility may perform a number of tests and measurements on the battery of an electric vehicle to determine the battery's charge capacity, the battery's charge rate, etc.

In some embodiments, the facility determines patterns and preferences of individuals who interact with the environment, such as when residents of a home awake or return home from work, when employees of a business arrive and leave for work, the preferred temperature conditions during various stages, etc., and retrieves information about external conditions that may impact the use of the energy system, such as weather conditions/forecasts and energy pricing information. The facility may determine these patterns by monitoring sensors and/or components distributed through the system and surrounding environment or receiving direct input from a user.

In some embodiments, the facility generates a simulation model for the energy system and surrounding environment based on the attributes identified while in learning mode. The simulation model specifies the amount of energy used by the energy system to transition between various states—such as transitions between different thermostat set points, change levels, etc.—using different components of the energy system under different operating conditions. For example, an HVAC system may be configurable to heat a building using a different combination of components (e.g., fans and blowers) and different settings for those components, such as operating a central heating unit and/or blower at full capacity while heating a building, operating the central heating unit at 50% while operating fans and blowers at 75%, and so on, each combination of settings offering different levels of energy consumption. In addition to (or alternatively to) the combinations of components and settings described herein, different combinations of components and settings can be used during the process of generating a simulation model.

Using the simulation model and the determined user preferences, the facility can simulate a number of different schedules for the energy system, each schedule specifying times for transitioning components of the energy system between states and operating conditions, such as a time to turn on a central heating unit and an operating level (e.g., full capacity, 25%, 75%) for the central heating unit while heating a building before individuals (e.g., residents, employees, or customers) arrive/depart. In some examples, the facility performs an optimization technique on the simulation model (e.g., a meta-heuristic optimization technique, the Particle Swarm Optimization technique described by J. Kennedy and R. Eberhart in Particle Swarm Optimization (Proc. IEEE International Conf. on Neural Networks (Perth, Australia), IEEE Service Center, Piscataway, N J, 1995), which is herein incorporated by reference), to identify an optimal schedule. During the simulations, the facility may employ user preferences, such as minimum and maximum temperatures or minimum and maximum energy consumption levels, as limits for acceptable schedules to prevent the system from operating under conditions that a user would find unacceptable. After performing the simulations, the facility can determine, for each simulated schedule, both 1) the amount of energy consumed by the energy system if the schedule were to be implemented and 2) if energy pricing information is known to the facility, the cost of implementing the schedule. Based on user preferences, the facility can choose a schedule for implementation, such as the schedule with the lowest cost or energy consumption. Additionally, the facility can choose a schedule for implementation that best satisfies a utility objective (e.g., demand reduction) with no adverse impact to the user(s).

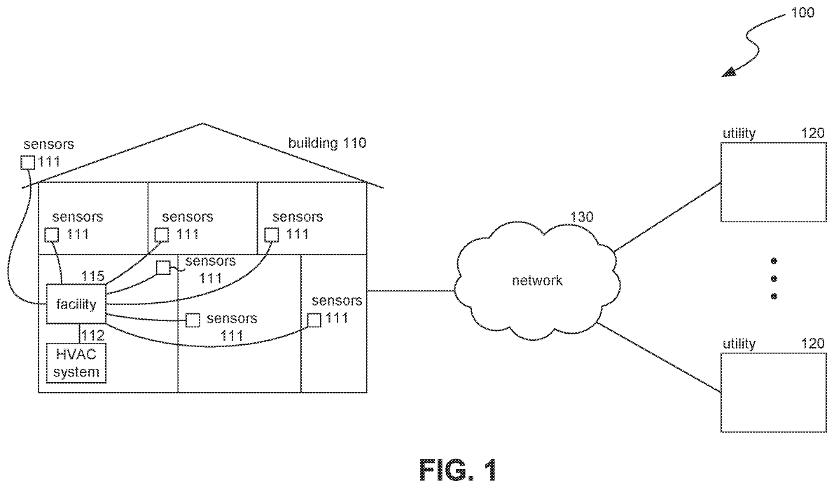

FIG. 1 is a block diagram illustrating an environment in which the facility may operate in some embodiments. The environment 100 includes building 110, HVAC system 112, facility 115, and a plurality of sensor sets 111. Building 110 may represent any type of building, such as a house, office building, stadium, apartment complex, etc. Sensor sets 111, which communicate with the facility, may include any number and type of sensor for detecting and measuring operating and environmental conditions, such as thermostats, thermometers, motion detectors, windows or door sensors (e.g., sensors to detect whether windows and doors are open), sensors for detecting fan/blower speed, central heating unit settings, occupancy sensors, sensors measuring site-generated energy production, audio/video recording devices, etc. Although in this example each area of building 110 includes a set of sensors, one skilled in the art will recognize that the facility may be used in an environment with any number of sensors and/or areas with sensors. HVAC system 112 represents the heating and cooling system of building 110 and includes, for example, heating components (not shown), cooling components (not shown), conduit (not shown), vents (not shown), etc. used for heating and cooling building 110. Environment 100 also includes utilities 120, which provide energy services (e.g., electricity), weather information, and other utility services to building 110. In some examples, the facility may also download information from the utilities pertaining to energy costs information, such as cost schedules (e.g., how much energy costs per unit at different times of the day, month, year) or demand schedules that indicate the utility's preferred energy consumption levels at various times of the day, month, year, etc. Building 110 and facility 115 may communicate with utilities 120 via network 130. Although the facility is shown in conjunction with an HVAC system in this example, one skilled in the art will understand that the techniques described herein can be used to detect and determine various attributes of any energy system, such as a dishwasher, washer, dryer, electric vehicle (and/or charger), solar panel systems, etc., or any combination thereof, and optimize the energy consumption of these systems.

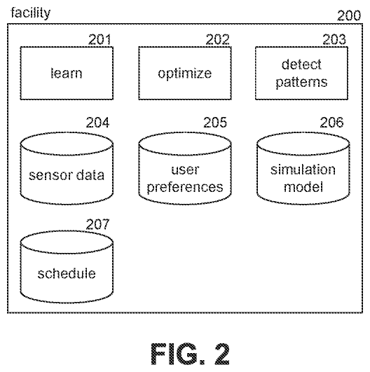

FIG. 2 is a block diagram illustrating components of the facility in some embodiments. In this example, facility 200 includes learn module 201, optimize module 202, detect patterns module 203, sensor data store 204, user preferences store 205, simulation model store 206, and schedule store 207. Learn module 201 is invoked by the facility to detect and determine information about an associated energy system and the environment in which the system operates. Optimize module 202 is invoked by the facility to optimize an energy system based on attributes of the system, environment, and user preferences. Detect patterns module 203 is invoked by the facility to detect patterns of individuals who interact with the system, such as when and where the individuals interact with the system (e.g., which rooms the individuals occupy, when windows are open, when and how thermostats in various rooms are adjusted) and patterns of the system and surrounding environment (e.g., when people arrive/depart, weather patterns). Sensor data store 204 stores information collected from each of the various sensor sets, such as data about the temperature of a room over time, the presence of individuals within those rooms, when and how various components of the system are adjusted, etc.

User preferences store 205 stores user preferences, such as preferred temperature settings (which may be time-based if a user prefers different temperatures based on the time of day, month, or year), preferred energy consumption goals (e.g., a preference to reduce consumption or costs), etc. Simulation model store 206 stores attributes of a simulation model generated based on attributes of an energy system and the surrounding environment. Schedule store 207 stores schedules for the system, such as the schedule that optimizes the system for a user's preferences. This schedule can be provided to the system to facilitate implementation of the user preferences.

The computing devices on which the disclosed facility is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the technology, which means a computer-readable medium that contains the instructions. In addition, the instructions, data structures, and message structures may be stored or transmitted via a data transmission medium, such as a signal on a communications link and may be encrypted. Various communications links may be used, such as the Internet, a local area network, a wide area network, a point-to-point dial-up connection, a cell phone network, and so on.

The disclosed facility may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

Many embodiments of the technology described herein may take the form of computer-executable instructions, including routines executed by a programmable computer. Those skilled in the relevant art will appreciate that aspects of the technology can be practiced on computer systems other than those shown and described herein. Embodiments of the technology may be implemented in and used with various operating environments that include personal computers, server computers, handheld or laptop devices, multiprocessor systems, microprocessor-based systems, programmable consumer electronics, digital cameras, network PCs, minicomputers, mainframe computers, computing environments that include any of the above systems or devices, and so on. Moreover, the technology can be embodied in a special-purpose computer or data processor that is specifically programmed, configured or constructed to perform one or more of the computer-executable instructions described herein. Accordingly, the terms “computer” or “system” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a CRT display or LCD.

The technology can also be practiced in distributed environments, where tasks or modules are performed by remote processing devices linked through a communications network. In a distributed computing environment, program modules or subroutines may be located in local and remote memory storage devices. Aspects of the technology described herein may be stored or distributed on computer-readable media, including magnetic or optically readable or removable computer disks, as well as distributed electronically over networks. Data structures and transmissions of data particular to aspects of the technology are also encompassed within the scope of the technology.

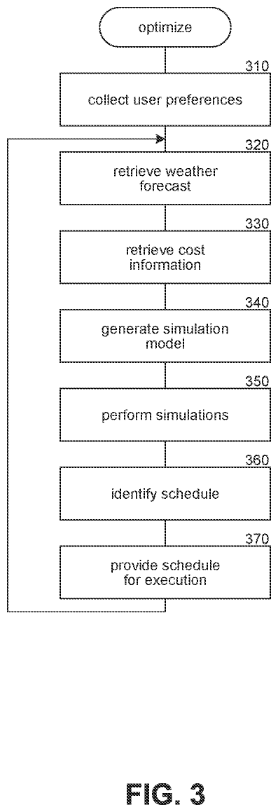

FIG. 3 is a block diagram illustrating the processing of an optimize module in some embodiments. The optimize module is invoked by the facility to optimize an energy system based on attributes of the system, environment, and user preferences. In block 310, the facility collects user preferences. For example, the module may retrieve input, such as thermostat settings and related scheduling information, to determine a user's preferred temperature setting at various times of the day. In some cases, the module may retrieve this information by querying one or more modules of the system, such as thermostats placed throughout a building. In some cases, the facility may provide a user interface through which a user may enter their preferences. Additionally, a user may specify their preferred energy consumption goals, such as reducing consumption, reducing costs, or some combination thereof.

In block 320, the facility retrieves a weather forecast, which may include forecasted temperatures and weather conditions for a predetermined number of hours, days, etc. In block 330, the module retrieves current and/or forecasted energy cost information (e.g., a cost schedule indicating a flat rate of 7.5 ¢ per kWh, a cost schedule indicating 5 ¢ per kWh for the first 10 kWh per day and 10 ¢ for each additional kWh per day, a cost schedule indicating various prices for each hour, or a range of times, of the day). In block 340, the module generates a simulation model based on the attributes detected and determined while in the learning mode. In block 350, the module performs simulations based on the generated simulation model, each simulation providing a schedule and estimated energy consumption over the course of the schedule.

In block 360, the module identifies the schedule with the preferred energy consumption (e.g., the schedule resulting in the lowest cost based on the retrieved cost information or the schedule resulting in the lowest overall consumption of energy). For example, the schedule may specify that a central heating unit of an HVAC system is to be turned on at 80% of capacity at 6:00 am with blowers operating at 75% and then turned off at 8:00 pm and then turned on again at 70% capacity at 4:45 pm before being turned off at 11:00 pm. In block 370, the facility provides the identified schedule to the system for implementation and then loops back to block 320. For example, the facility may communicate a schedule of set points to a thermostat for implementation. In some embodiments, the optimize process occurs frequently throughout the day to incorporate new and/or changed information into the optimization, such as occupant overrides, updated forecasts (e.g., weather and cost), schedule changes, etc. Furthermore, this process may occur on demand according to information provided by an energy provider, such as demand response events.

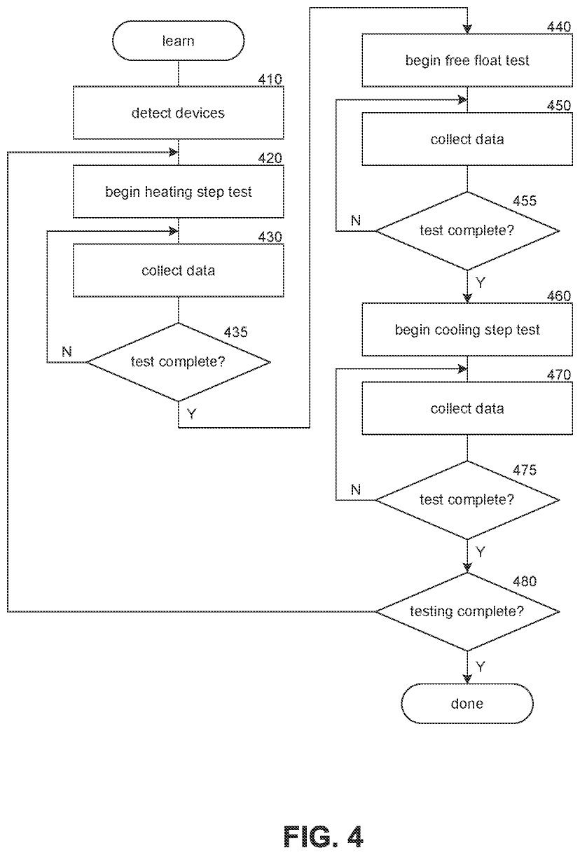

FIG. 4 is a block diagram illustrating the processing of a learn module in some embodiments. The facility invokes the learn module to detect and determine various attributes of the associated energy system. In this example, the module is invoked to determine and detect the attributes of heating and cooling system, such as an HVAC system. In block 410, the learn module identifies devices and components of the system by, for example, querying the system to provide this information, receiving manual input from a user, or performing know system identification techniques. In block 420, the learn module performs a heating step test by heating up the building in which the HVAC system operates and monitoring various conditions of the system and surrounding environment.

In block 430, the learn module collects data to assess how the system and environment changes during the heating step test, such as the rate at which the environment heats up (i.e. stores and retains heat), and that can be used to determine attributes of the system and environment. The heating step test may include, for example, heating the environment at one degree (or more) increments at a time based on the temperature measured at a predetermined location and collecting data from each of the sensors as the environment heats, including an indication of the amount of energy consumed by the system as the environment transitions between temperatures. In some cases, the learn module may perform the heating step test multiple times using different operating configurations (e.g., different operating levels—such as 0% to 100%—for a central heating unit, fans, blowers, vents, etc.) or under different operating conditions. In decision block 435, if the heating step test is complete then the learn module continues at block 440, else the module loops back to block 430 to collect additional data generated during the heating step test.

In block 440, the learn module performs a free float test. During the free float test, the facility turns off the HVAC system to monitor how the environment retains, loses, or gains heat without input from the HVAC system. In block 450, the learn module collects data from the available sensors to assess how the system and environment changes during the free float step test and that can be used to determine attributes of the system and environment. In decision block 455, if the free float test is complete, then the learn module continues at block 460, else the module loops back to block 450 to collect additional data generated during the free float test.

In block 460, the module performs a cooling step test to collect data while cooling down the environment. In block 470, the learn module collects data to assess how the system and environment changes during the cooling step test, such as the rate at which the environment cools down and where heat is lost, and that can be used to determine attributes of the system and environment. The cooling step test may include, for example, cooling the environment at one degree (or more) increments, based on, for example, the temperature measured at a predetermined location and collecting data from each of the sensors as the environment cools, including an indication of the amount of energy consumed by the system as the environment transitions between temperatures. In some cases, the learn module may perform the cooling test multiple times using different operating configurations (e.g., different operating levels—such as 0% to 100%—for an air conditioner, fans, blowers, vents, etc.) or under different operating conditions. In decision block 475, if the cooling step test is complete, then the module continues at decision block 480, else the module loops back to block 470 to collect additional data generated during the cooling step test. In decision block 480, if testing is complete then the learn module terminates processing, else the module loops back to block 420 to continue testing.

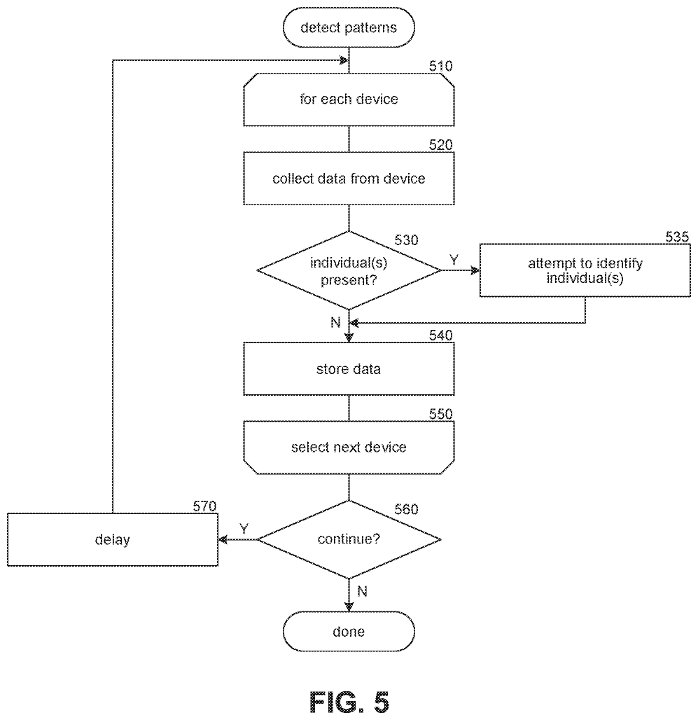

FIG. 5 is a block diagram illustrating the processing of a detect patterns module in some embodiments. The facility invokes the detect patterns module to detect a) patterns of individuals who interact with the system, such as when and where the individuals interact with the system, and b) patterns of the system and surrounding environment. The facility may invoke the module periodically (e.g., once per hour, once per day, once per week, once per month), upon request from a user, and/or in response to changes to the system, such as an adjustment to a thermostat or a modified schedule. In blocks 510-545 the detect patterns module loops through each of the devices available to the module to collect information from those devices. The devices may include, for example, sensors, appliances, thermostats, HVAC components, electric vehicles, and so on.

In block 520, the detect patterns module collects data from the device, such as its current operating condition, current configuration, and so on. In decision block 530, if the detect patterns module determines that one or more individuals are present in the vicinity of the device (e.g., based on data collected from a presence or proximity sensor) then the module continues at block 535, else the module continues at block 540. In block 535, the detect patterns module attempts to identify the individual(s) using, for example, an object carried by an individual, such as an RFID tag, voice or face recognition techniques if audio or video data is available, and so on. In this manner, the facility can associate different individuals with preferred settings. For example, if the facility determines that a thermostat is regularly adjusted to 68 degrees when a particular individual enters a room, the facility may associate the particular individual with a preferred temperature of 68 degrees. Furthermore, by detecting individuals the module allows the facility to detect patterns among individuals with respect to their interactions with the system, such as when they arrive and leave.

In block 540, the detect patterns module stores the data collected from the device, time information (e.g., a time stamp), and an indication of the presence of any individual. In block 550, if there are additional devices from which data has not been collected, then the detect patterns module selects the next device and loops back to block 510. In decision block 560, if the module is to continue checking devices, then the module continues at block 570, else processing of the module completes. In block 570, the detect patterns module waits a predetermined period of time (e.g., 1 milliseconds, 1 hour, 24 hours, 7 days, a month) and then loops back to block 510 to continue processing data from the devices.

From the foregoing, it will be appreciated that specific embodiments of the technology have been described herein for purposes of illustration, but that various modifications may be made without deviating from the disclosure. The facility can include additional components or features, and/or different combinations of the components or features described herein. Additionally, while advantages associated with certain embodiments of the new technology have been described in the context of those embodiments, other embodiments may also exhibit such advantages, and not all embodiments need necessarily exhibit such advantages to fall within the scope of the technology. For example, the facility may operate in conduction with an energy-producing system Accordingly, the disclosure and associated technology can encompass other embodiments not expressly shown or described herein.

1-23. (canceled)

24. A method for controlling a heating, ventilation, and air condition (HVAC) system based on one or more user preferences for an environment coupled to the HVAC system, the method comprising:
receiving an input from a user to adjust a setting of a first component from one or more components of the HVAC system;
in response to the input:
collecting data from the first component, and
associating the collected data with a user profile for the user;
storing the associated data as a user pattern in the user profile, wherein the associated data includes the collected data, the user profile, a time associated with the input, and wherein the user pattern identifies one or more adjustments for the user; and
providing the user profile to the HVAC system for adjustment of a setting of at least one component of the one or more components to achieve at least one user preference in the environment.

25. The method of claim 24 wherein the user is a first user from a plurality of users, and wherein the method further comprises, in response to the input, identifying the first user from the plurality of users.

26. The method of claim 25 wherein identifying the first user includes detecting an RFID tag associated with an identity of the first user, detecting the identity of the first user using a voice recognition technique, and/or detecting the identity of the first user using face recognition technique.

27. The method of claim 24 wherein the user is a first user from a plurality of users and the first user has a first user profile, and wherein the method further comprises:
in response to the input, detecting a second user in a vicinity of the first component from a presence sensor; and
associating the collected data with a second user profile for the second user.

28. The method of claim 27, further comprising, in response to detecting the second user in the vicinity of the first component, identifying the second user.

29. The method of claim 24 wherein collecting data from the first component includes retrieving information associated with external conditions including at least one of a weather condition, weather forecast, schedule of energy costs, and energy pricing information.

30. The method of claim 24 wherein the input is an adjustment to a temperature set point of a thermostat.

31. The method of claim 24 wherein the HVAC system comprises two or more components, and wherein the method further comprises, in response to the input:
collecting data for each component from the two or more components; and
associating the collected data on each of the two or more components with the user profile for the user.

32. A non-transitory computer-readable medium storing instructions for controlling an energy consuming system that, if executed by a computing system having a processor, cause the computing system to perform operations comprising:
for a first component from a plurality of components in the energy consuming system, receiving an input from a user to adjust a setting of the first component;
in response to the input:
collecting data from the first component, and
associating the collected data with a user profile associated with the user;
storing the associated data as a user pattern in the user profile, wherein the associated data includes the collected data, a time associated with the input, and wherein the user pattern identifies one or more adjustments for the user; and
providing the user profile to the energy consuming system for adjustment of a setting of at least one component of the plurality of components to achieve at least one user preference for the energy consuming system.

33. The non-transitory computer-readable medium of claim 32 wherein the plurality of components are a plurality of appliances including an air-conditioning unit, a fan, a blower, a pump, a water heater, a dishwasher, a refrigerator, a sensor, a photovoltaic system, a rechargeable battery, and/or an electric car.

34. The non-transitory computer-readable medium of claim 32 wherein the energy consuming system is a heating, ventilation, and air condition (HVAC) system.

35. The non-transitory computer-readable medium of claim 32 wherein the user is a first user from a plurality of users with a first user profile, and wherein the operations further comprise:
in response to the input, detecting a one or more second users in a vicinity of the first component from a presence sensor; and
for each of the one or more second users, associating the collected data with a second user profile for the second user.

36. The non-transitory computer-readable medium of claim 35 wherein, in response to detecting the one or more second users in the vicinity of the first component, identifying each of the one or more second users.

37. The non-transitory computer-readable medium of claim 32 wherein the input includes at least one of a schedule and user preferences for the first component.

38. The non-transitory computer-readable medium of claim 32 wherein the user is a first user from a plurality of users, and wherein the operations further comprise, in response to the input, identifying the first user from the plurality of users.

39. A computer system for controlling a heating, ventilation, and air condition (HVAC) system based on one or more user preferences, the computer system comprising:
at least one processor; and
at least one memory storing computer-executable instructions that, when executed by the at least one processor, control the computer system to:
receive an input from a user to adjust a setting of a first component from one or more components of the HVAC system;
in response to the input, the computer-executable instructions control the computer system to:
collect data from the first component, and
associate the collected data with a user profile for the user;
store the associated data as a user pattern in the user profile, wherein the associated data includes the collected data, the user profile, a time associated with the input, and wherein the user pattern identifies one or more adjustments for the user; and
provide the user profile to the HVAC system for adjustment of a setting of at least one component of the one or more components to achieve at least one user preference.

40. The computer system of claim 39 wherein the input is an adjustment to a temperature set point of a thermostat.

41. The computer system of claim 39 wherein the computer-executable instructions further cause the computer system to:
generate a simulation model of the HVAC system at least in part by determining an envelope resistance parameter of the HVAC system, determining a thermal capacitance parameter of the HVAC system, determining a heating capacity parameter of the HVAC system, and/or determining a cooling capacity parameter of the HVAC system; and
generating a schedule of adjustments applicable to the HVAC system based on the simulation model and the user profile.

42. The computer system of claim 39 wherein the user is a first user from a plurality of users, and wherein the computer-executable instructions further cause the computer system to identify the first user.

43. The computer system of claim 39 wherein the user profile further includes a user schedule associated with a setting preference for the first component.
